(19) United States
(12) Patent Application Publication
(10) Pub. No.: US 2011/0203246 A1
(43) Pub. Date: Aug. 25, 2011

(54) End weighted mower blade

(76) Inventor: Charles Ernest Daffin, III, Tallahassee, FL (US)

(21) Appl. No.: 12/660,005

(22) Filed: Feb. 19, 2010

(51) Int. Cl. A01D 34/13

(52) U.S. Cl. 56/289

(57) ABSTRACT

A mower blade generally comprised of a rotor which connects to the mower at an attachment point and at least one outer end of the rotor, wherein the outer end or ends of the rotor are heavier than the rotor proximate the attachment point. The added weight to the outer end can be by way of an extension or an end section.

### FIELD OF THE INVENTION

The present invention relates to mower blades and, more particulary, to the weight or mass distribution of the blades center compared to the blades outter most end.

### BACKGROUND OF THE INVENTION

When mower blades are new, they cut just fine. But after wear from use, they start loosing mass or weight on the outer end. Also from repeated sharpening the blade looses mass on the cutting edge, which is the outer most end of the blade. As the blade end loses such mass or weight, it becomes less efficient at cutting and eventually has to be replaced with a new, unworn, blade. What is needed is a blade that does not loose its cutting efficiency after wear from use and sharpening. And such remedy would also increase the cutting power of the blade.

Am not aware of any solutions to date

It would be advantageous to provide a mower blade that can wear and continue to efficiently cut.

It would also be advantageous to provide a mower blade that after continuous sharpening, would still contain enough weight on the outer cutting edge to keep its kinetic energy. The blades power of impact and damage.

It would further be advantageous to provide a mower blade that would add extra cutting power to the mower by increasing the blades outer end mass.

### SUMMARY OF THE INVENTION

In accordance with the present invention, there is provides a mower blade with the most mass or weight on the outer, cutting edge. It is just that simple. Instead of having the blade mass relatively constant throughout the length, center pivot to outside cutting end, shift more mass to the outside. Leaving less mass or weight at the center pivot. Will work for any mower blade or any other rotating cutting blade. Shifting the most mass to the outer edge, creating a substantial weight difference between the center and the outer edges, will increase the kinetic energy of the outer cutting edge. Giving the mower more cutting power and increasing the useful life of the blade. Most all individual mowers, mow at a constant speed. At the mowing RPM the mower blade is spinning at a constant RPM. The velocity of the outside cutting edge is always moving at the same velocity or speed. So without increasing the blade speed, in order to generate more cutting power, this invention creates more mass or weight at the outter cutting edge to generate more power. “kinetic energy is a measure of work (or damage) that something can do if it collides with something else. The larger the speed and/or the larger the mass, the larger the kinetic energy, and thus the greater the impact” nmsea.org. E−Kinetic=½ mass×velocity×velocity. And as previously mentioned, added mass at the outer end, the cutting edge, gives the blade more damage power and a longer efficient cutting life. There will be less percentage of mass or weight loss at the outer blade end.

Increase in cutting end mass or weight can be built in, added, can be in width or could be in thickness, but not limited to these.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a top plan view of a standard mower blade at the top of the page and the invention proposed at the bottom of the page. the invention showing more mass at the outside cutting edge;

FIG. 2 is a top plan view of a different way to have more mass on the outer cutting edge than there is at the non cutting center; and

FIG. 3 is a perspective view of a standard blade at the top. invention in the center with more mass on the outside by increasing blade width. the invention blade at the bottom view, achieving desired result by increasing thickness on the outside.

For purposes of clarity and brevity, like elements and components will bear the same designations and numbering throughout the Figures.

### DESCRIPTION OF THE PREFERRED EMBODIMENT

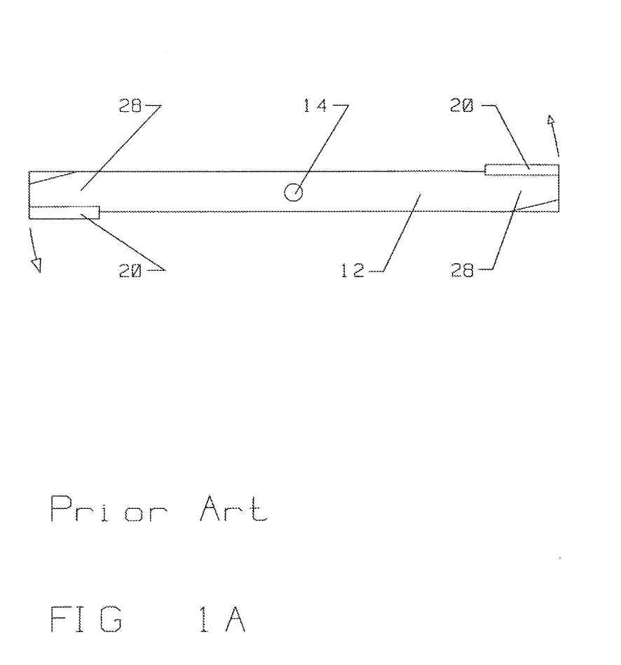

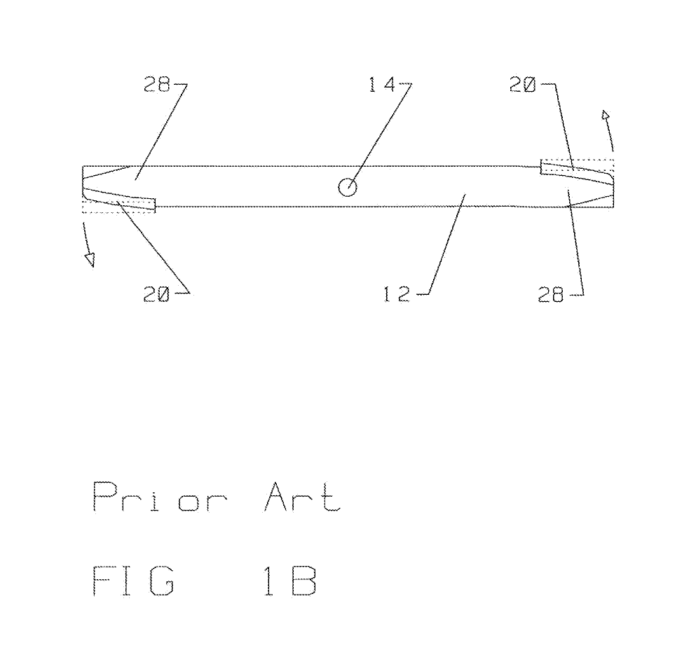

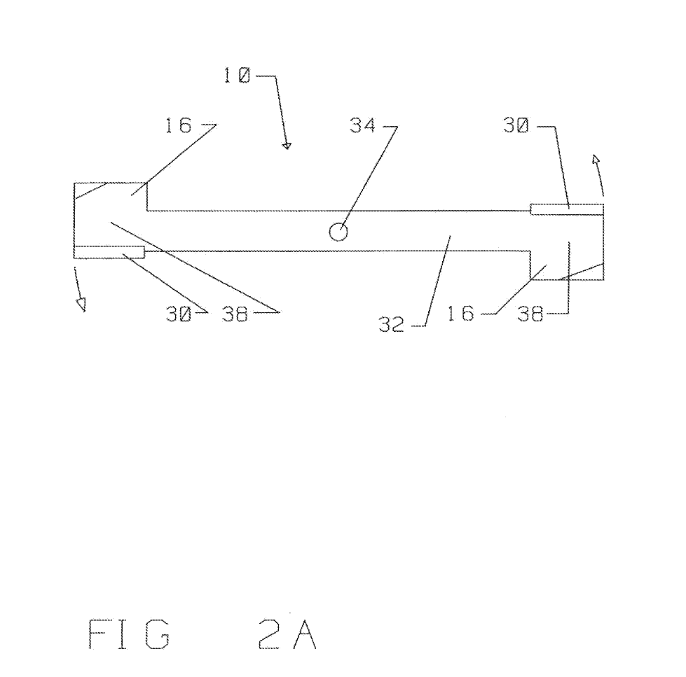

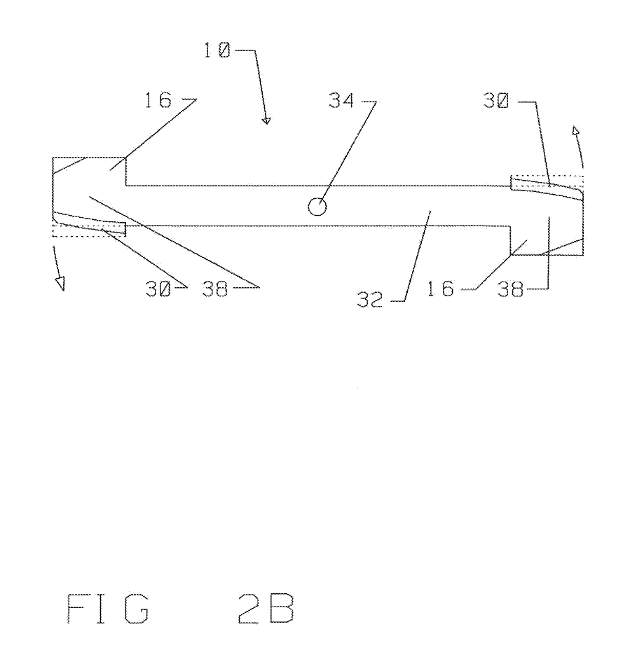

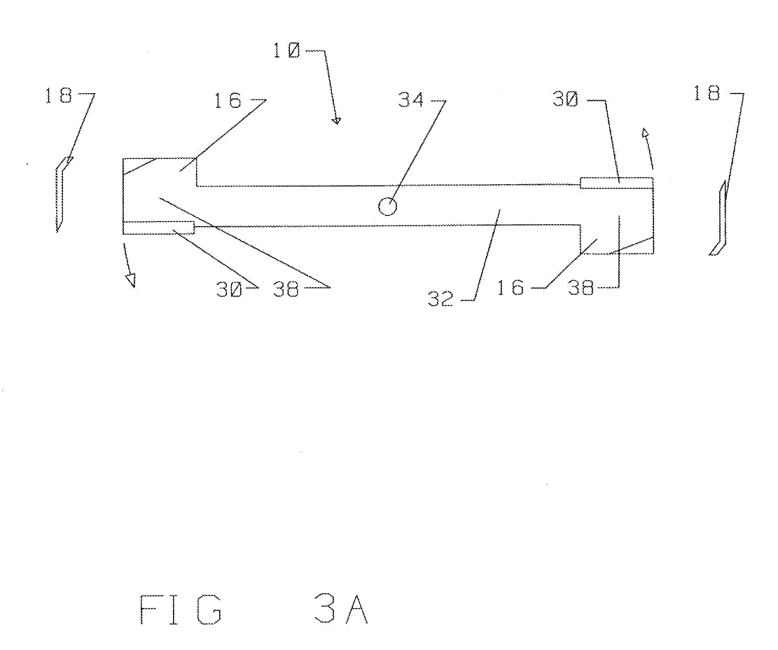

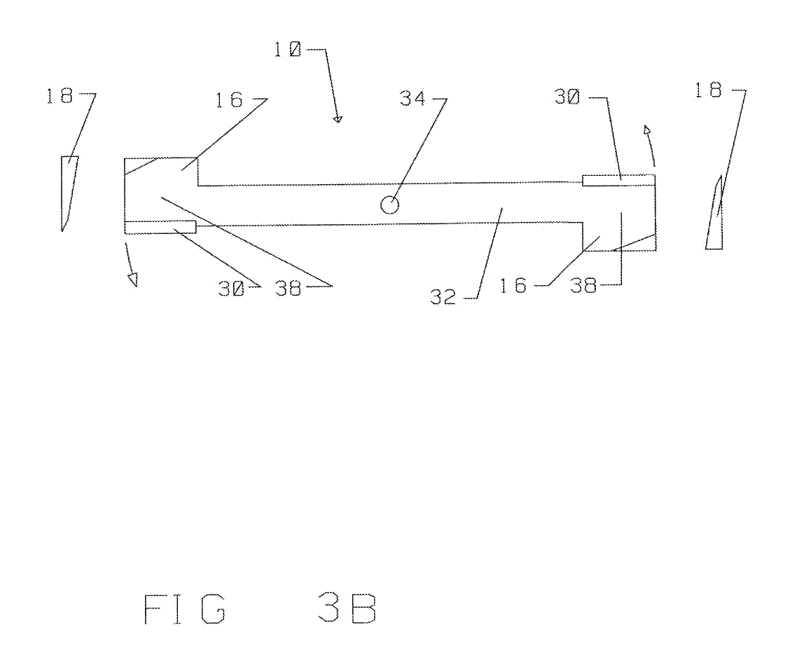

FIG. 1 is a top plan view. Showing a standard mower blade at the top two, and the invention proposed at the bottom two. The bottom two blades having more mass at the outside cutting edge 20. The top two blades are typical mower blades, showing the center hole of rotation 14, the cutting edge 20 on the outer end 28. The standard blade 12 has basically the same size througout. Same thickness and width from center hole of rotation 14 to outer end 28 at the cutting edge 20. Some blades do have minor shape changes but not enough to be relevant to a substantial increase in mass on the outer end 28. The second blade down from the top is the same standard blade 12 with a worn edge 22. The worn edge 22 has reduced the mass on the outer cutting edge 20, causing a significant decrease in cutting potential. Because of less mass, the energy delivered is now less, which equals less damage to the object being cut. This kind of wear on a standard blade 12 could reduce its cutting efficiency by 25% +/−. The third blade down from the bottom is the invention. A blade with added or increased weight or mass 16 on the outer cutting edge 20. Generating more energy to the object(s) being cut. The bottom blade is the invention. Showing a worn edge 22. Because the outer end 28 with the cutting edge 20 has so much more added or increased weight or mass 16, the loss from wear is insignificant. The blade will still do damage and will not have to be replaced. Note: the arrows at the outer end 28, show direction of rotation 10.

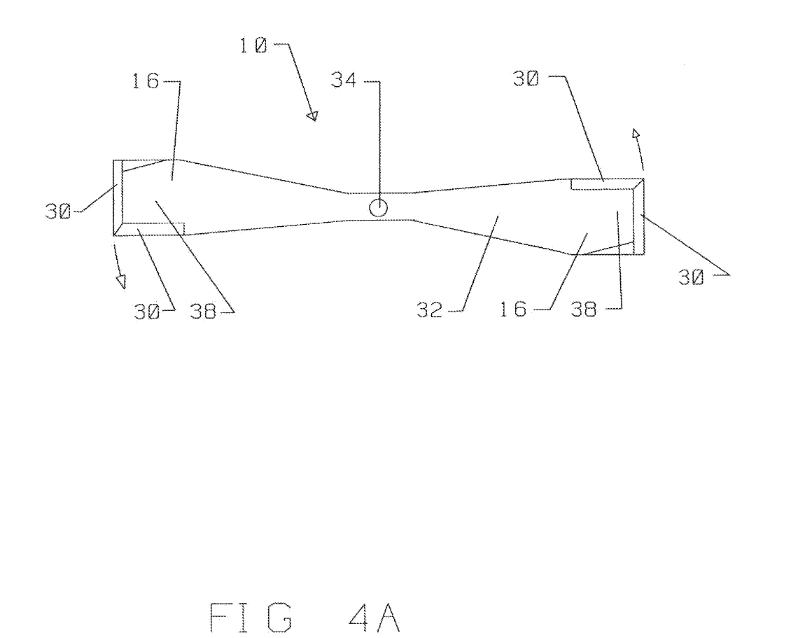

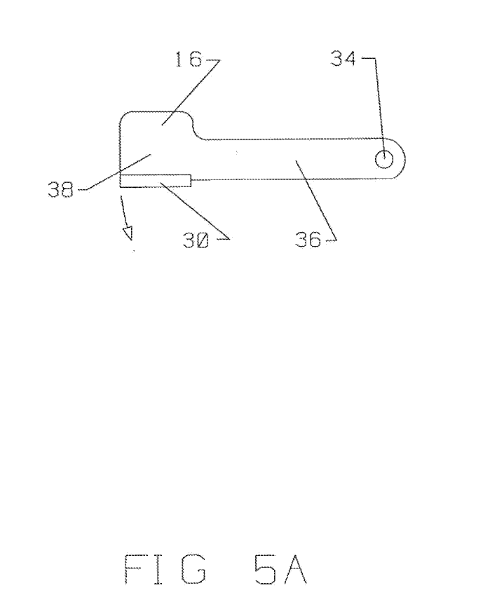

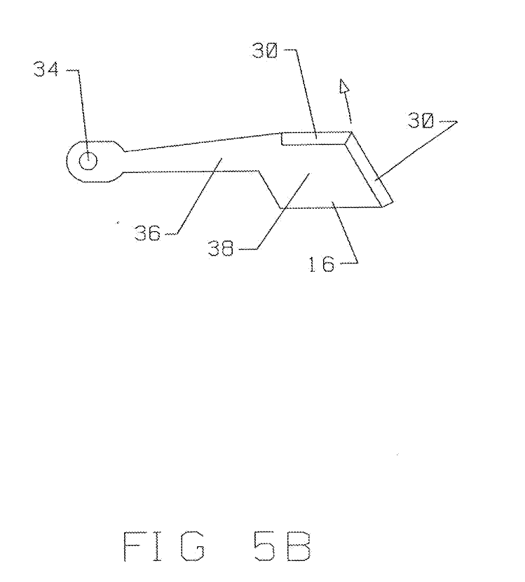

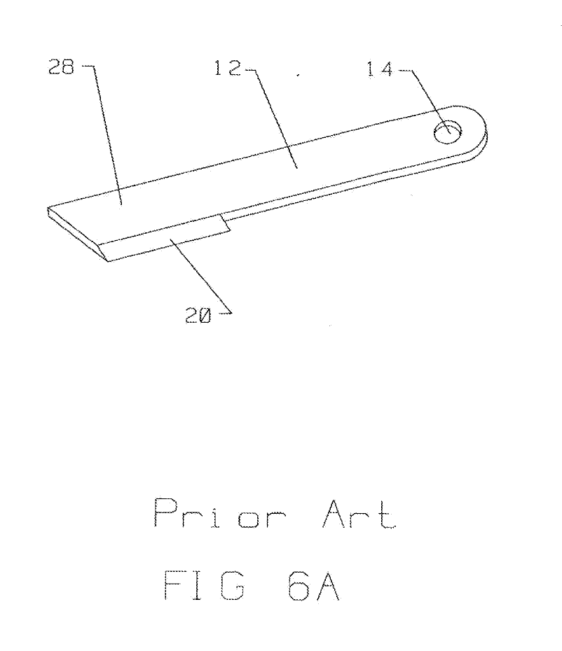

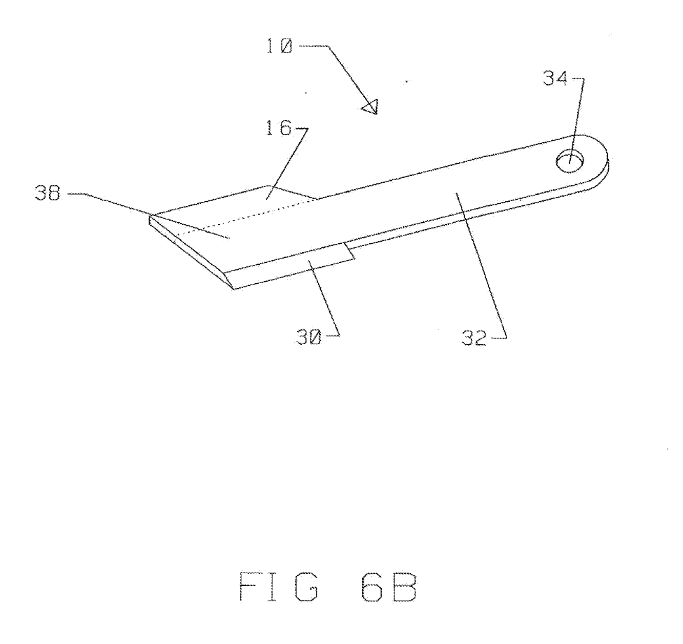

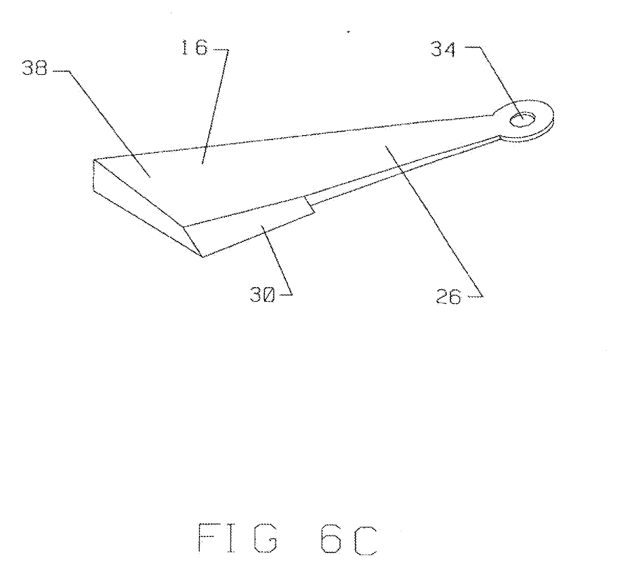

FIG. 2 is a top plan view of different ways to have more mass on the outer end 28 where the cutting edge 20 is located, and having the lesser mass at the “non cutting” center, or closest point to the center hole of rotation 14. All blades shown are the invention in different designs but not limited to just these shapes. Top two blades show added or increased mass at the outer end 28 behind the cutting edge 20. Off the left side of the top two blades, are an end section 18 view, of which, the lower one shows added or increased weight or mass 16 by increasing thickness on the outer end 28. The cutting end being thicker 24 than the center hole of rotation 14. The rest of the blades are different shapes achieving the samed added or increased weight or mass 16 on the outer end 28 at the cutting edge 20 of the blade.

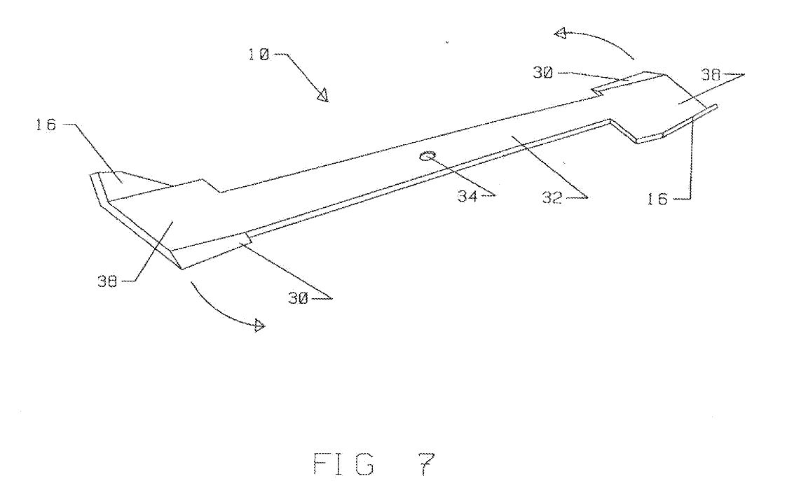

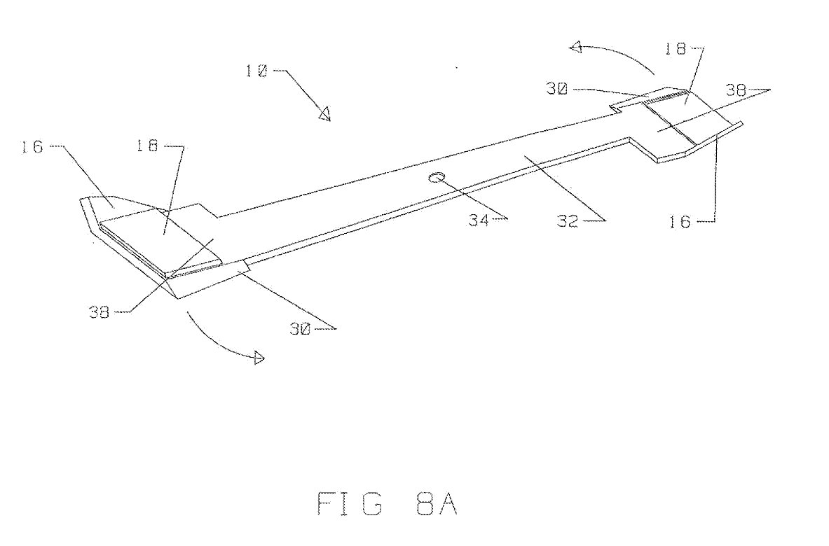

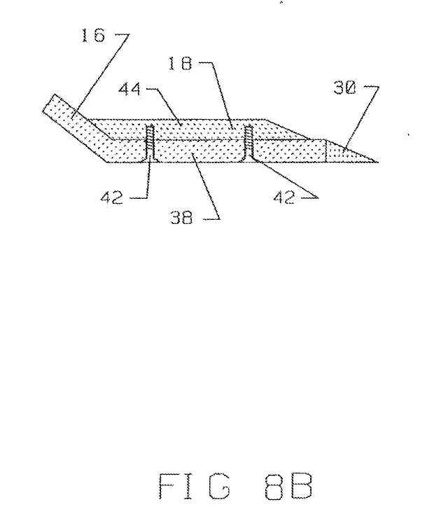

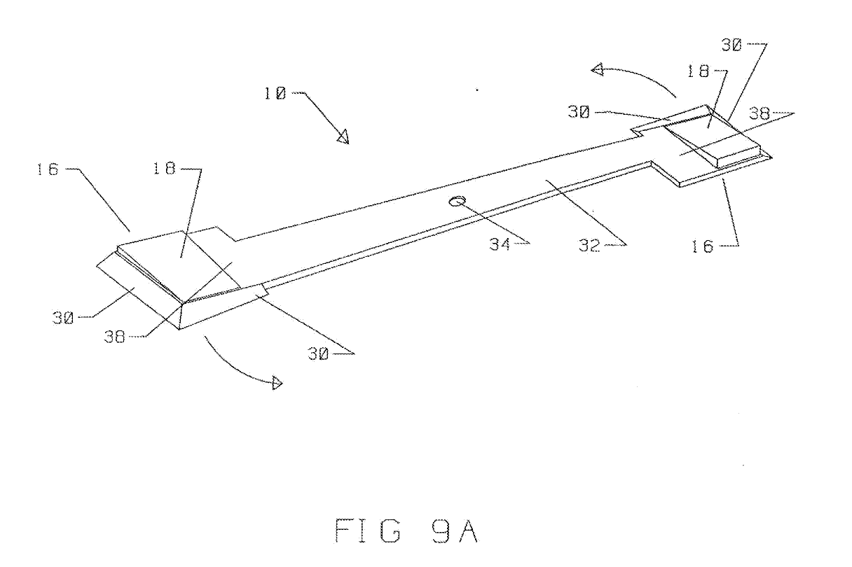

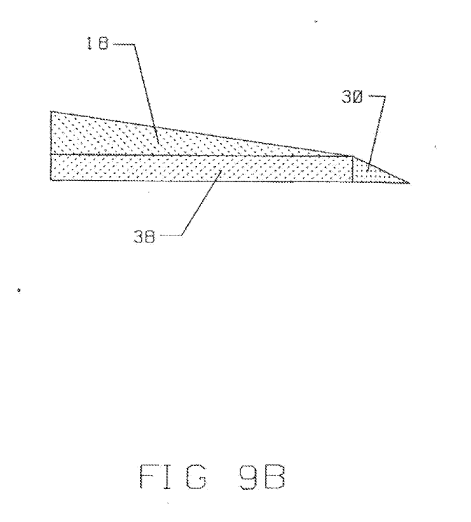

FIG. 3 is a perspective view of a standard blade 12 at the top. The center blade is the invention, creating more mass on the outer end 28 by increasing blade width. The bottom blade is also the invention a achieving the desired result by increasing thickness on the outer end 28. The views are of a blade design for use on “bushhog” type mowers. The standard blade 12 view at the top and the invention, middle and bottom blade, views. The middle blade shows Added or increased weight or mass 16 by width and/or thickness to the outer end 28. Increasing the energy to be delivered by the cutting edge 20. The bottom blade shows an optional thicker 24 outside with a thinner 26 inside, closest to the center hole of rotation 14.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

1-6. (canceled)

7. A mower blade, comprising:
a. a rotor which connects to said mower at an attachment point, said rotor lying within a plane and having a direction of rotation;
b. at least one outer end of said rotor, said at least one outer end of said rotor having a direction of travel corresponding to said direction of rotation of said rotor;
c. wherein said at least one outer end further comprises,
i. a cutting edge lying within said plane of said rotor, said cutting edge facing said direction of travel for said at least one outer end,
ii. a trailing edge lying within said plane of said rotor, said trailing edge facing opposite said direction of travel for said at least one outer end,
iii. an extension extending from said trailing edge in a direction opposite said direction of travel for said at least one outer end, said extension lying within said plane of said rotor;
d. wherein said extension substantially increases a mass of said at least one outer end in comparison to a mass of a remainder of said rotor.

8. The mower blade of claim 7, wherein said at least one outer end of said rotor has a width that is greater than said width of said rotor at said attachment point.

9. (canceled)

10. The mower blade of claim 8, wherein an upturned end section is attached to said extension at said at least one outer end of said rotor.

11. A mower blade, comprising:
a. a rotor having an attachment point a direction of rotation and at least two outer ends, said rotor lying within a plane;
b. wherein said rotor connects to said mower at said attachment point;
c. wherein said rotor proximate said attachment point weighs less than said rotor proximate said outer ends of said rotor;
d. wherein at leat one of said outer ends further comprises:
i. a cutting edge lying within said plane of said rotor, said cutting edge facing said direction of travel for said at least one outer end,
ii. a trailing edge lying within said plane of said rotor, said trailing edge facing opposite said direction of travel for said at least one outer end,
iii. an extension extending from said trailing edge in a direction opposite said direction of travel for said at least one outer end, said extension lying within said plane of said rotor; and
e. wherein said extension substantially increases a mass of said at leat one outer end in comparison to a mass of a remainder of said rotor.

12. The mower blade of claim 11, further comprising a second outer cutting edge angularly displaced from said first outer cutting edge.

13. A mower blade, comprising:
a. a rotor connected to said mower at an attachment point, wherein said rotor proximate said attachment point has a first weight;
b. at least one outer end of said rotor having a second weight;
c. wherein said weight of said outer end of said rotor is greater than said weight of said rotor proximate said attachment point;
d. wherein said rotor lies within a plane and has a direction of rotation, with said at least one outer end having a direction of travel corresponding to said direction of rotation of said rotor;
e. wherein said at least one outer end further comprises;
i. a cutting edge lying within said plane of said rotor, said cutting edge facing said direction of travel for said at least one outer end,
ii. a trailing edge lying within said plane of said rotor, said trailing edge facing opposite said direction of travel for said at least one outer end,
iii. an extension extending from said trailing edge in a direction opposite said direction of travel for said at least one outer end, said extension lying within said plane of said rotor; and
f. wherein said extension substantially increases a mass of said at least one outer end in comparison to a mass of a remainder of said rotor.

14. The mower blade of claim 13, wherein said weight of said outer end of said rotor is comprised of a heavier material than said rotor proximate said attachment point.
